(19) United States
(12) Patent Application Publication
(10) Pub. No.: US 2026/0349308 A1
(43) Pub. Date: Nov. 5, 2026

(54) DISPLAY DEVICE COMPRISING PRIVACY PROTECTION FILM

(71) Applicant: LG Display Co., Ltd., Seoul (KR)

(72) Inventors: Junehwan Kim, Hwaseong-si (KR); JungIm Hwang, Gimpo-si (KR)

(73) Assignee: LG Display Co., Ltd., Seoul (KR)

(21) Appl. No.: 19/661,020

(22) Filed: Apr. 28, 2026

(30) Foreign Application Priority Data
Apr. 30, 2025 (KR) 10-2025-0057374

(51) Int. Cl. G02F 1/167; G02F 1/1677

(52) U.S. Cl. CPC G02F 1/167; G02F 1/1677

(57) ABSTRACT

A display device includes a display panel and a privacy protection film disposed above the display panel and selectively restricting a viewing angle, the privacy protection film includes a first substrate, a first electrode disposed on the first substrate, a decor resin layer disposed on the first electrode, including a plurality of accommodation portions and implementing an external light reflection image, a second electrode disposed on the decor resin layer, a second substrate disposed on the second electrode, and an ink received in each of the plurality of accommodation portions and including a plurality of charged pigment particles and a solvent having an electrical polarity, and the decor resin layer includes optical interference particles.

### CROSS-REFERENCE TO RELATED APPLICATION(S)

This application claims the priority of Korean Patent Application No. 10-2025-0057374 filed on Apr. 30, 2025, in the Ministry of Intellectual Property of the Republic of Korea, the disclosure of which is incorporated herein by reference.

### BACKGROUND

### Field

The present disclosure relates to a privacy protection film and a display device including the same, and more particularly, to a display device including a privacy protection film for a vehicle capable of implementing a wide viewing angle mode and a narrow viewing angle mode and implementing the same visibility as the interior material of the vehicle in a narrow viewing angle mode and a non-driving mode.

### Discussion of the Related Art

As the demand for personal privacy protection increases, various related products are being developed in various places. Among products that guarantee personal privacy, the demand for privacy protection devices that are attached to various display devices such as mobile phones, tablet PCs, and monitors to block lateral light transmission and narrow the viewing angle is also increasing.

In this regard, conventionally, a privacy protection film in the form of a film in which a light transmitting area that transmits light and a light blocking area that blocks light in a specific direction are alternately formed has been used. Of the light incident from the lower portion, light having an incident angle of a predetermined angle or more is absorbed or blocked by a light blocking area repeatedly formed, and thus cannot pass through the privacy protection film. As a result, the light transmittance is significantly reduced at a viewing angle equal to or greater than a predetermined angle, so that privacy protection may be implemented. However, in the case of the conventional privacy protection film, the viewing angle cannot be restored to the existing state unless the film itself is removed, so there is an inconvenience of removing the film when the privacy function is unnecessary.

Recently, in order to solve such inconvenience, a privacy protection film capable of selectively switching a wide viewing angle mode and a narrow viewing angle mode according to an electrical signal applied from the outside without attaching or detaching a film has been developed.

However, in the conventional switchable privacy protection film, light is blocked in a narrow viewing angle mode, so that only a black image is visually recognized, and there is a limitation from an aesthetic point of view. For example, the display device may be included in a vehicle to provide various information to a driver and a passenger of the vehicle. The display device for a vehicle may impair the aesthetics of the interior of the vehicle.

### SUMMARY

An object of the present disclosure is to provide a privacy protection film capable of implementing various colors and images other than a black image in a narrow viewing angle mode, and a display device including the same.

Another object of the present disclosure is to provide a privacy protection film applicable to a display device for a vehicle and implementing a visibility similar to an interior trim material in a vehicle.

Objects of the present disclosure are not limited to the above-mentioned objects, and other objects, which are not mentioned above, can be clearly understood by those skilled in the art from the following descriptions.

To achieve these objects and other advantages of the present disclosure, as embodied and broadly described herein, a display device according to an example embodiment of the present disclosure includes a display panel and a privacy protection film disposed above the display panel and selectively restricting a viewing angle, the privacy protection film includes a first substrate, a first electrode disposed on the first substrate, a decor resin layer disposed on the first electrode and including a plurality of accommodation portions and implementing an external light reflection image, a second electrode disposed on the decor resin layer, a second substrate disposed on the second electrode, and an ink received in each of the plurality of accommodation portions and including a plurality of charged pigment particles and a solvent having an electrical polarity, and the decor resin layer includes optical interference particles.

Other detailed matters of example embodiments are included in the detailed description and the drawings.

According to an example embodiment of the present disclosure, the privacy protection film includes charged pigment particles to implement a wide viewing angle mode and a narrow viewing angle mode. At the same time, the privacy protection film includes optical interference particles to implement a reflective image visible to a user at a narrow viewing angle mode or when the display panel is not driven.

According to an example embodiment of the present disclosure, by adjusting the configuration of the optical interference particles, it is possible to variously adjust the reflected image such as color or pattern due to constructive interference of the reflected light.

According to an example embodiment of the present disclosure, in the display device used in a vehicle, it is possible to improve aesthetics by matching with an interior trim material in a non-driving vehicle.

The effects according to the present disclosure are not limited to the contents exemplified above, and more various effects are included in the present disclosure.

### BRIEF DESCRIPTION OF DRAWINGS

The accompanying drawings, which are included to provide a further understanding of the present disclosure and are incorporated in and constitute a part of this application, illustrate various example embodiments of the present disclosure and together with the description serve to explain various principles of the disclosure.

FIG. 1 is a schematic cross-sectional view of a display device including a privacy protection film according to an example embodiment of the present disclosure.

FIG. 2A is a schematic cross-sectional view of a case in which the privacy protection film is in a narrow viewing angle mode in the display device according to an example embodiment of the present disclosure.

FIG. 2B is a schematic cross-sectional view of a case in which the privacy protection film is in a wide viewing angle mode in the display device according to an example embodiment of the present disclosure.

FIG. 3A is a schematic cross-sectional view for illustrating image implementation by external light reflection when the privacy protection film is in a wide viewing angle mode and the display panel is in a non-driving mode in the display device according to an example embodiment of the present disclosure.

FIG. 3B is a schematic cross-sectional view for illustrating image implementation by external light reflection when the privacy protection film is in a wide viewing angle mode and the display panel is in a driving mode in the display device according to an example embodiment of the present disclosure.

FIG. 3C is a schematic cross-sectional view for illustrating image implementation by external light reflection when the privacy protection film is in a narrow viewing angle mode and the display panel is in a driving mode in the display device according to an example embodiment of the present disclosure.

FIG. 4 is a schematic cross-sectional view of a display device including a privacy protection film according to another example embodiment of the present disclosure.

FIG. 5 is cross-sectional views for illustrating a method of manufacturing a privacy protection film according to an example embodiment of the present disclosure.

FIG. 6 is a schematic cross-sectional view of a display device according to yet another example embodiment of the present disclosure.

FIG. 7 is a schematic cross-sectional view of a display device according to yet another example embodiment of the present disclosure.

FIG. 8 is an example view in which a display device according to an example embodiment of the present disclosure is applied to a vehicle.

FIG. 9 is a table showing results of evaluating luminance with respect to a viewing angle and a reflected image implemented according to a driving mode of each of Examples 1, 2, Comparative Example, and Reference Examples.

### DETAILED DESCRIPTION

Advantages and characteristics of the present disclosure and a method of achieving the advantages and characteristics will be clear from example embodiments described below in detail together with the accompanying drawings. However, the present disclosure is not limited to the example embodiments disclosed herein but may be implemented in various forms. The example embodiments are provided by way of example only so that those skilled in the art can more fully understand the disclosures of the present disclosure and the scope of the present disclosure.

The shapes, sizes, ratios, angles, numbers, and the like illustrated in the accompanying drawings for describing the example embodiments of the present disclosure are examples, and the present disclosure is not limited thereto. Further, in the following description of the present disclosure, a detailed explanation of known related technologies may be omitted to avoid unnecessarily obscuring the subject matter of the present disclosure. The terms such as “including,” “having,” and “consist of” used herein are generally intended to allow other components to be added unless the terms are used with a more specific term like “only”. Any references to singular may include plural, and vice versa, unless expressly stated otherwise.

Components are interpreted to include an ordinary error range even if not expressly stated.

When the position relation between two parts is described using the terms such as “on”, “above”, “below”, and “next”, one or more parts may be positioned between the two parts unless the terms are used with a more specific term like “immediately” or “directly”.

When an element or layer is disposed “on” another element or layer, another layer or another element may be interposed directly on the other element or therebetween.

Although the terms “first”, “second”, and the like are used for describing various components, these components are not confined by these terms. These terms are merely used for referring to one component separately from the other components. Therefore, a first component to be mentioned below may be a second component, and vice versa, in a technical concept of the present disclosure.

Like reference numerals generally denote like elements throughout the disclosure.

A size and a thickness of each component illustrated in the drawing are illustrated for convenience of description, and the present disclosure is not limited to the size and the thickness of the component illustrated.

The features of various embodiments of the present disclosure can be partially or entirely adhered to or combined with each other and can be interlocked and operated in technically various ways, and the example embodiments can be carried out independently of or in association with each other.

Hereinafter, the present disclosure will be described in detail with reference to the drawings.

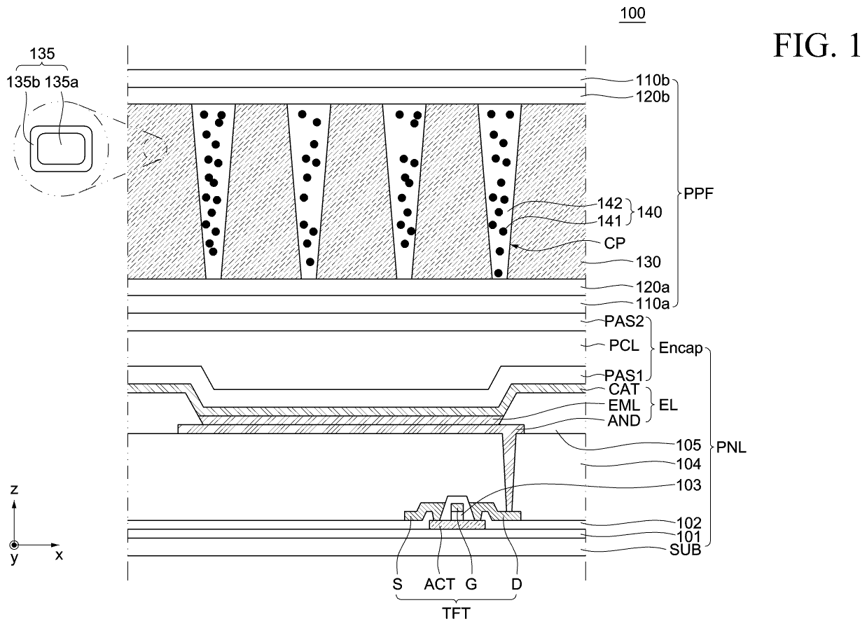

FIG. 1 is a schematic cross-sectional view of a display device including a privacy protection film according to an example embodiment of the present disclosure.

The display device 100 according to the example embodiment of the present disclosure includes a display panel PNL and a privacy protection film PPF.

The display panel PNL is a panel in which images are implemented and may be an organic light emitting display panel PNL or a liquid crystal display panel PNL, but is not limited thereto. Hereinafter, the description will be made on the assumption that the display panel PNL is an organic light emitting display panel.

The display panel PNL includes a substrate SUB, a thin film transistor TFT, an organic light emitting element EL, and an encapsulation layer Encap.

The substrate SUB is a substrate for supporting various elements of the display panel PNL and may be formed of an insulating material. For example, the substrate SUB may be a glass substrate or a plastic substrate. For example, the plastic substrate may be selected from polyimide, polyethersulfone, polyethylene terephthalate, and polycarbonate, but is not limited thereto.

A buffer layer 101 may be disposed on the substrate SUB to prevent or protect the elements of the display device from being deteriorated by oxygen or moisture. The buffer layer 101 may be formed as a single layer or may be formed in a multi-layered structure if necessary.

A thin film transistor TFT including a gate electrode G, an active layer ACT, a source electrode S, and a drain electrode D is disposed on the buffer layer 101. In FIG. 1, for the convenience of description, only a driving thin film transistor TFT among various thin film transistors TFT that may be included in the display device 100 is illustrated. In addition, in FIG. 1, it is described that the thin film transistor TFT has a coplanar structure as an example, but is not limited thereto, and a thin film transistor TFT having an inverted staggered structure may also be used.

For example, the active layer ACT is disposed on the buffer layer 101 and a gate insulating layer 103 for insulating the active layer ACT and the gate electrode G is disposed on the active layer ACT. Further, an interlayer insulating layer 102 for insulating the gate electrode G, the source electrode S, and the drain electrode D is disposed on the buffer layer 101. The source electrode S and the drain electrode D respectively contacting the active layer ACT are formed on the interlayer insulating layer 102. A planarization layer 104 may be disposed on the thin film transistor TFT. The planarization layer 104 planarizes the upper portion of the thin film transistor TFT. The planarization layer 104 may include a contact hole for electrically connecting the thin film transistor TFT and the anode AND of the organic light emitting element EL.

The organic light emitting element EL is disposed on the planarization layer 104. The organic light emitting element EL includes an anode AND, a cathode CAT, and an organic emission layer EML.

The anode AND is disposed on the planarization layer 104. The anode AND is a component for supplying holes to the organic emission layer EML and is formed of a conductive material having a high work function. The anode AND may be a transparent conductive layer formed of transparent conductive oxide (TCO). For example, the anode AND may be formed of one or more selected from transparent conductive oxides such as indium-tin-oxide (ITO), indium-zinc-oxide (IZO), indium-tin-zinc oxide (ITZO), tin oxide (SnO2), zinc oxide (ZnO), indium-copper-oxide (ICO), and aluminum: zinc oxide (Al:ZnO, AZO), but is not limited thereto.

The bank 105 is disposed on the anode AND and the planarization layer 104. The bank 105 defines an emission area by covering an edge of the anode AND. The bank 105 may be formed of an insulating material to insulate each anode AND from each other. Further, the bank 105 may be configured as a black bank having a high light absorption rate to prevent or suppress color mixture between adjacent organic light emitting devices.

The cathode CAT is disposed on the anode AND. The cathode CAT may be formed of a metal material having a low work function to smoothly supply electrons to the organic emission layer EML. For example, the cathode CAT may be formed of a metal material selected from calcium (Ca), barium (Ba), aluminum (Al), silver (Ag), and an alloy including one or more of them, but is not limited thereto. The cathode CAT is not patterned, but is formed as one layer on the anode AND. When the display device 100 is driven as a top emission type, the cathode CAT may be formed to have a very thin thickness to be substantially transparent.

The organic emission layer EML is disposed between the anode AND and the cathode CAT. The organic emission layer EML is a layer in which electrons and holes are coupled to emit light.

In order to improve luminous efficiency of the display panel PNL, a hole injection layer, a hole transport layer, an electron transport layer, an electron injection layer, and the like may be further included. For example, a hole injection layer and a hole transport layer may be disposed between the anode AND and the organic emission layer EML, and an electron transport layer and an electron injection layer may be disposed between the organic emission layer EML and the cathode CAT. In addition, a hole blocking layer or an electron blocking layer may be disposed to further improve the recombination efficiency of holes and electrons in the organic emission layer EML.

An encapsulation layer Encap is disposed on the cathode CAT to minimize or reduce deterioration of the organic light emitting display panel due to moisture or oxygen. The encapsulation layer Encap planarizes the upper surface of the display panel PNL. The encapsulation layer Encap may have a multi-layered structure in which an inorganic layer formed of an inorganic insulating material and an organic layer formed of an organic material are stacked. For example, the encapsulation layer Encap includes at least one organic layer PCL and at least two inorganic layers PAS1 and PAS2, and may have a multi-layered structure in which an inorganic layer and an organic layer PCL are alternately stacked, but is not limited thereto. For example, the encapsulation layer Encap may have a triple-layered structure including a first inorganic layer PAS1, an organic layer PCL, and a second inorganic layer PAS2. For example, the first inorganic layer PAS1 and the second inorganic layer PAS2 may each be independently formed of one or more selected from silicon nitride (SiNx), silicon oxide (SiOx), silicon oxynitride (SiON), or aluminum oxide (Al2O3), but are not limited thereto. For example, the organic layer PCL may be formed of one or more selected from epoxy resin, polyimide, polyethylene, and silicon oxy carbon (SiOC), but is not limited thereto.

If necessary, a touch sensor unit may be disposed on the encapsulation layer Encap to selectively impart a touch sensing function to the display device 100.

Hereinafter, a privacy protection film PPF capable of implementing user privacy protection by selectively restricting a viewing angle in the display device will be described.

A privacy protection film PPF is disposed on the display panel PNL.

The privacy protection film PPF is applied to an organic light emitting display device or a liquid crystal display device and operates in a wide viewing angle mode in which, when an electric field is formed, light incident at various angles from the bottom is well transmitted so that an image displayed on the display device can be observed not only on the front surface of the display device but also on the side surface thereof. On the contrary, when an electric field is not formed, light having an incident angle greater than or equal to a predetermined angle among light incident from the lower portion is absorbed. Accordingly, privacy protection may be implemented by operating in a narrow viewing angle mode that allows a user to view an image displayed on the display device only in the front surface of the display device or within a certain narrow angle range.

As shown in FIG. 1, the privacy protection film PPF includes a first substrate 110a, a first electrode 120a, a decor resin layer 130 having a plurality of accommodation portions CP, an ink 140, a second electrode 120b, and a second substrate 110b.

The first substrate 110a may be formed of a transparent insulating material. For example, the first substrate 110a may be formed of an insulating polymer selected from polyethylene terephthalate (PET), polymethyl methacrylate (PMMA), polycarbonate (PC), and polyimide (PI).

For example, the thickness of the first substrate 110 a may be 10 μm to 50 μm, but is not limited thereto.

The first electrode 120a is disposed on the first substrate 110a. The first electrode 120a may be formed of a transparent conductive material to transmit light incident from the bottom well. For example, the transparent conductive material may be at least one selected from indium-tin-oxide (ITO), indium-zinc-oxide (IZO), indium-tin-zinc-oxide (ITZO), aluminum-zinc-oxide (AZO), and the like, but is not limited thereto.

The first electrode 120a may be formed on the front surface of the first substrate 110a and may be patterned to selectively overlap the plurality of accommodation portions CP as necessary.

For example, the thickness of the first electrode 120 a may be 10 μm to 30 μm, but is not limited thereto.

The decor resin layer 130 is disposed on the first electrode 120a. The decor resin layer 130 transmits the internal light incident from the lower portion of the privacy protection film PPF and implements a reflected image through external light incident from the upper portion of the privacy protection film PPF. Specifically, the decor resin layer 130 upwardly transmits light emitted from the display panel PNL disposed below the privacy protection film PPF, such that the user may recognize the image implemented from the display panel PNL. Meanwhile, the decor resin layer 130 may implement a reflective image such as a color or a pattern through constructive interference of reflected light during a process of reflecting external light incident from the upper portion of the privacy protection film PPF. A detailed description of implementing the reflected image through the decor resin layer 130 will be described later.

The decor resin layer 130 may include the optical interference particles 135 and the base resin.

The optical interference particle 135 is a material that causes constructive interference of light at a plurality of interfaces and may be a plate-shaped particle having a core-shell structure. The optical interference particles 135 include a core 135a made of a low refractive material and a shell 135b surrounding the core 135a and made of a high refractive material.

The core 135a is disposed at a central portion of the optical interference particle 135. The core 135a is a material that determines mechanical strength and transparency, and may be made of a low refractive material. For example, the refractive index of the core 135a may be 1.8 or less or 1.6 or less, but is not limited thereto.

Specifically, the core 135a may include a layered clay compound, an inorganic oxide, or a low refractive polymer. For example, the layered clay compound may be one or more selected from mica, smectite, vermiculite, clorite, montmorillonite, MMT, nontronite, saponite, hectorite, and bentonite, but is not limited thereto. The inorganic oxide may be at least one selected from silica (SiO2) or alumina (Al2O3) or porous inorganic oxide, but is not limited thereto. Further, the low refractive polymer is a polymer having a refractive index of 1.8 or less or 1.6 or less, and may be one or more selected from polyester, polyacrylonitrile, polystyrene, nylon, polypropylene, polyvinyl alcohol, polycarbonate, polyethylene naphthalate, polyethyleneterephthalate, polymethylmethacrylate, polyetheretherketone, polyparaphenylene terephthalate, polyphenylene sulfide, or a copolymer thereof, but is not limited thereto.

The core 135a may have a plate shape having a width and a length longer than a thickness. For example, the size of the core 135a is 3 μm or less, and the thickness-to-plate long ratio may be 1:2 to 1:100 or 1:5 to 1:50, but is not limited thereto.

The shell 135b is disposed to surround the surface of the core 135a. The shell 135b is a material that determines the reflection intensity due to external light and the color of the decor resin layer 130 due to reflected light, and may be made of a high refractive material. For example, the refractive index of the shell 135b may be greater than the refractive index of the core 135a, and may be greater than or equal to 0.2 or more or equal to 0.4 or more of the refractive index of the core 135a. Specifically, the refractive index of the shell 135b may be 1.8 or more or 2.0 or more, but is not limited thereto.

Specifically, the shell 135b may be made of an inorganic oxide. For example, the shell 135b may be one or more selected from alumina (Al2O3), titania (TiO2), iron oxide (Fe2O3), zirconia (ZrO2), ceria (CeO2), and vanadia (V2O5), but is not limited thereto.

The thickness of the shell 135b may be adjusted according to the color of the decor resin layer 130 by reflected light to be implemented. For example, the thickness of the shell 135b may be 50 nm to 300 nm, but is not limited thereto.

With respect to the entire decor resin layer 130, the optical interference particles 135 may be included in an amount of 1.0% to 20.0 wt % or 2.0% to 10.0 wt %. When the content of the optical interference particles 135 is smaller than the above range, the reinforcing interference effect of the reflected light is insufficient to implement the color of the decor resin layer 130 by the reflected light, and when the content of the optical interference particles 135 is larger than the above range, the total transmittance of the decor resin layer 130 is degraded to degrade the luminance of the display device.

The base resin may be a transparent insulating resin capable of transmitting light incident from the lower portion. For example, the resin may include an acrylic resin, and specifically, may be an acrylic resin formed by curing a urethane acrylate-based compound. The acrylic resin formed from the urethane acrylate-based compound has advantages of high curability, high transparency, and high adhesion properties. For example, the decor resin layer 130 may include a urethane acrylate-based compound in an amount of 80% to 99% by weight, but is not limited thereto.

A plurality of receiving portions CP are formed in the decor resin layer 130. Each of the plurality of accommodation portions CP accommodates the ink 140 capable of absorbing light incident from the outside. The plurality of accommodation portions CP are grooves formed in the decor resin layer 130 and are formed on the first electrode 120a to face the second electrode 120b.

Each of the plurality of receiving portions CP is disposed to be spaced apart from each other at a predetermined interval along a first direction (x-axis direction) perpendicular to the thickness direction (z-axis direction) of the decor resin layer 130.

Each of the plurality of accommodation portions CP extends in a second direction (y-axis direction) perpendicular to the first direction (x-axis direction). That is, each of the plurality of accommodation portions CP may extend from one corner of the first electrode 120a toward another corner parallel thereto, and may be formed in a stripe structure on the first electrode 120a.

Each of the plurality of accommodation portions CP may be formed such that a width thereof increases from the first electrode 120a toward the second electrode 120b. That is, the width of the upper surface of each of the plurality of accommodation portions CP is larger than the width of the lower surface. Even though in the drawing, it is illustrated that a cross-sectional shape of each of the plurality of accommodation portions CP is an inverted trapezoidal shape, it is not limited thereto.

Each of the plurality of receiving portions CP may be formed to penetrate the decor resin layer 130, but is not limited thereto. For example, each of the plurality of accommodation portions CP may be formed to be spaced apart from any one of the first electrode 120a and the second electrode 120b. That is, only one of the upper and lower surfaces of the decor resin layer 130 may be opened so that the decor resin layer 130 does not penetrate.

The ink 140 is disposed to be accommodated in each of the plurality of accommodation portions CP. The ink 140 may absorb light incident from the outside in the plurality of accommodation portions CP.

The ink 140 includes charged pigment particles 141 and a solvent 142. The charged pigment particles 141 are light absorbing materials and function to absorb light incident from the outside substantially within the ink 140. The solvent 142 uniformly disperses charged pigment particles 141, which are solid content, into the plurality of receiving portions CP so as not to be precipitated by gravity. Accordingly, the pigment particles 141 charged in the solvent 142 are uniformly dispersed, and the ink 140 exhibits a black color.

The charged pigment particles 141 have an electrical polarity and may be positive or negative charged absorbing materials. Accordingly, charged pigment particles 141 uniformly dispersed in the solvent 142 are moved by the electric field formed therebetween when a voltage is applied to the first electrode 120a and the second electrode 120b. A detailed description thereof will be described later.

Specifically, the charged pigment particles 141 may be a light absorbing material surface-modified with a functional group having a negative charge. Specifically, the pigment particles 141 charged with negative charges may be dye particles surface-modified with one or more functional groups selected from a carboxylate group (—COO—), a sulfonate group (—SO3—), a sulfate group (SO42—), and Fluoride (F—).

The charged pigment particles 141 may have a black color. For example, the charged pigment particles 141 may include charged carbon nanotubes (CNT), charged carbon black, and charged electrophoretic particles, but are not limited thereto. In particular, the charged carbon nanotubes have a uniform surface area and a uniform surface shape and thus have a high charge amount and uniform characteristics. In this case, the bi-stability of the privacy protection film PPF is improved, the driving characteristics are improved, and the driving stability can be improved, especially at low temperatures.

With respect to the total content of the ink 140, the charged pigment particles 141 may be included in an amount of 0.1% to 5.0 wt %. When the content of the charged pigment particles 141 is too small, the light absorption effect may be deteriorated, and when the content is too large, dispersibility may be deteriorated.

The solvent 142 may be a non-polar solvent. For example, the solvent 142 comprises but is not limited to, aromatic hydrocarbons such as benzene, toluene, xylene, phenylxylylethane, diisopropylnaphthalene, and naphthenic hydrocarbons; aliphatic hydrocarbons such as hexane, dodecylbenzene, cyclohexane, kerosene, and paraffin hydrocarbons; halogenated hydrocarbons such as chloroform, trichloroethylene, tetrachloroethylene, trifluoroethylene, tetrafluoroethylene, dichloromethane, and ethyl bromide; phosphoric acid esters such as tricresyl phosphate, trioctyl phosphate, octyldiphenyl phosphate, and tricyclohexyl phosphate; phthalic acid esters such as dibutyl phthalate, dioctyl phthalate, dilauryl phthalate, and dicyclohexyl phthalate; carboxylic acid esters such as butyl oleate, diethylene glycol dibenzoate, dioctyl sebacate, dibutyl sebacate, dioctyl adipate, trioctyl trimellitate, acetyltriethyl citrate, octyl maleate, dibutyl maleate, and ethyl acetate; and isopropylbiphenyl, isoamylbiphenyl, chlorinated paraffin, diisopropylnaphthalene, 1,1-ditolylethane, 1,2-ditolylethane, 2,4-di-tert-aminophenol, and N,N-dibutyl-2-butoxy-5-tert-octylaniline.

Meanwhile, the ink 140 may further include additives such as a dispersant and a surfactant.

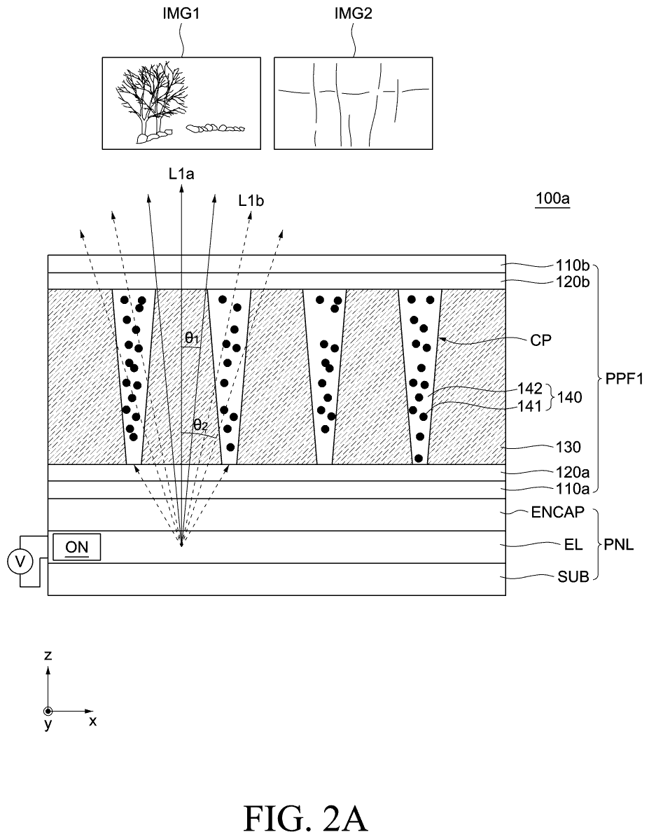

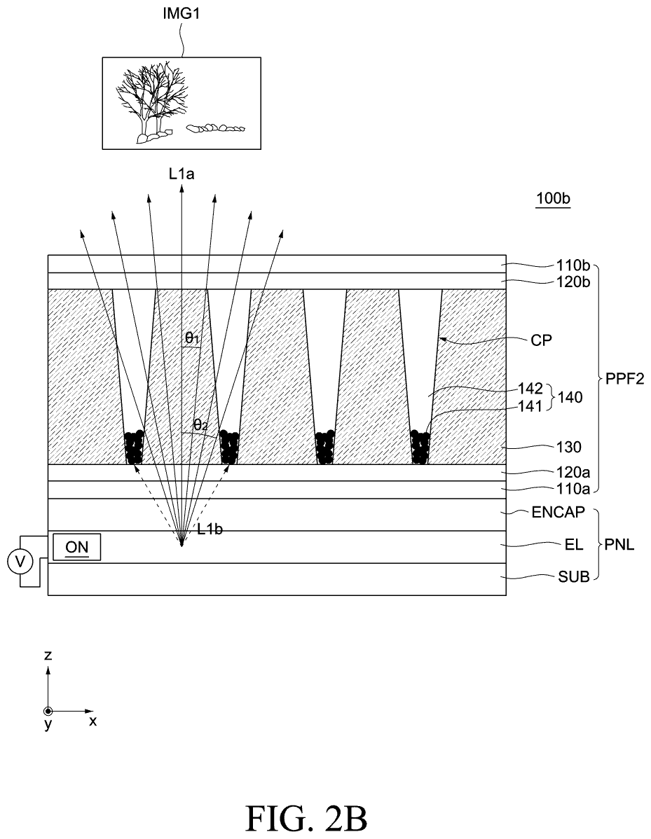

Hereinafter, each of the narrow viewing angle mode and the wide viewing angle mode will be described in detail with reference to FIGS. 2A and 2B together.

FIG. 2A is a schematic cross-sectional view of a case in which the privacy protection film is in a narrow viewing angle mode in the display device according to an example embodiment of the present disclosure. FIG. 2B is a schematic cross-sectional view of a case in which the privacy protection film is in a wide viewing angle mode in the display device according to an example embodiment of the present disclosure. In FIGS. 2A and 2B, some components of the display panel PNL are omitted and briefly displayed. Specifically, only the substrate SUB, the organic light emitting element EL, and the encapsulation layer Encap are displayed as components of the display panel PNL.

Meanwhile, in the display device illustrated in FIGS. 2A and 2B, the display panel PNL is a driving mode in which light is emitted from the organic light emitting element EL. That is, the switch of the display panel PNL is turned on to emit light from the display panel PNL and enter the privacy protection film PPF.

First, as shown in FIG. 2A, the privacy protection film PPF1 operates in a narrow viewing angle mode. When the electric field is not formed between the first electrode 120a and the second electrode 120b in the narrow viewing angle mode, the charged pigment particles 141 are uniformly dispersed in the solvent 142 to be randomly distributed in the plurality of accommodation portions CP. As the charged pigment particles 141 are randomly distributed in the plurality of receiving portions CP, the plurality of receiving portions CP absorbs incident light. Accordingly, light incident at an angle greater than or equal to a predetermined angle is blocked by the plurality of receiving portions CP.

That is, in the narrow viewing angle mode, light emitted from the display panel PNL and incident onto the privacy protection film PPF1 is absorbed by charged pigment particles 141 distributed in the plurality of accommodation portions CP so as not to be emitted to the outside of the privacy protection film PPF1. For example, among light emitted from the display panel PNL and incident to the bottom of the privacy protection film PPF1, light L1a incident into the first angle θ1 with respect to the front surface (z-axis) is emitted to the outside of the privacy protection film PPF1, but light L1b incident at an angle larger than the first angle θ1, for example, at the second angle θ2, is not emitted to the outside by charged pigment particles 141 in the accommodation part CP.

Accordingly, the user may view different images according to the viewing angle. As shown in FIG. 2A, at a viewing angle within the first angle θ1, the user may visually recognize the first image IMG1, which is an image displayed by the display panel PNL. However, at a viewing angle larger than the first angle θ1, the user cannot visually recognize the image displayed by the display panel PNL because the light emitted from the display panel PNL is not emitted to the outside by the privacy protection film PPF1. In this case, at a viewing angle larger than the first angle θ1, the user may visually recognize the second image IMG2, which is a reflected image implemented by the decor resin layer 130 of the privacy protection film PPF1. The second image IMG2 is an image implemented by constructive interference of reflected light and may have a color or a specific pattern shape. A detailed description of the reflected image implemented by the decor resin layer 130 will be described later.

In the display device 100a illustrated in FIG. 2A, the privacy protection film PPF1 may operate in a narrow viewing angle mode so that the image displayed by the display panel PNL is visually recognizable only at a viewing angle within a predetermined angle, and the image displayed by the display panel PNL cannot be visually recognized at a viewing angle exceeding the predetermined angle, thereby implementing privacy protection.

Next, as shown in FIG. 2B, the privacy protection film PPF2 is operated in a wide viewing angle mode. In the wide viewing angle mode, when an electric field is formed between the first electrode 120a and the second electrode 120b by applying a voltage, charged pigment particles 141 randomly distributed in the plurality of accommodation portions CP are moved toward the electrode by the electric field. That is, it moves toward the opposite electrode according to the type of charged charge of the charged pigment particles 141.

For example, in case that the charged pigment particles 141 are charged with negative charges, when a positive voltage is applied to the first electrode 120a and a negative voltage is applied to the second electrode 120b, the negatively charged pigment particles 141 move toward the lower surface of the receiving portion CP in contact with the first electrode 120a opposite thereto. Accordingly, the charged pigment particles 141 are accumulated at a predetermined height from the lower surface of the accommodation portion CP.

That is, most of the area except for the area adjacent to the lower surface of the accommodation portion CP in which the charged pigment particles 141 are stacked has a very low density of the charged pigment particles 141 to form a transparent layer. Accordingly, light may be transmitted to a transparent area where the density of the charged pigment particles 141 is low. As a result, in the wide viewing angle mode, among the light which is emitted from the display panel PNL and is incident onto the privacy protection film PPF2, the light which is incident at the first angle θ1 with respect to the front surface (z-axis) and light which is incident at the larger second angle θ2 may also be emitted to the outside. Compared to FIG. 2A, only light L1b incident at an angle greater than the second angle θ2 cannot be emitted to the outside by the charged pigment particles 141 in the receiving portion CP. Accordingly, the privacy protection film PPF2 illustrated in FIG. 2B may operate in the wide viewing angle mode as the traveling angle of light emitted to the outside of the privacy protection film PPF2 is increased compared to the case illustrated in FIG. 2A.

Accordingly, the user can visually recognize the image at a wide viewing angle. Specifically, as shown in FIG. 2B, at a viewing angle within the first angle θ1, the user may visually recognize the first image IMG1, which is an image displayed by the display panel PNL. In addition, even at the viewing angle of the second angle θ2, which cannot be visually recognized due to the narrow viewing angle mode in FIG. 2A, the user may visually recognize the first image IMG1, which is an image displayed by the display panel PNL.

As another example, when the charged pigment particles 141 are charged with a positive charge, a negative voltage is applied to the first electrode 120a and a positive voltage is applied to the second electrode 120b to operate the wide viewing angle mode in the same manner as in FIG. 2B, and a redundant description thereof will be omitted.

The viewing angle may be adjusted by a width of a lower surface of the accommodation part CP, a width of an upper surface, a height of the accommodation part CP, a distance between adjacent accommodation parts CP, and the like.

For example, the width of the bottom surface of the accommodation part CP may be 5 μm to 15 μm or 8 μm to 15 μm, the width of the top surface of the accommodation part CP may be 25 μm to 50 μm or 25 μm to 40 μm, and the height of the accommodation part CP may be 100 μm to 160 μm or 120 μm to 160 μm, and the separation distance between adjacent accommodation parts CP may be 30 μm to 60 μm. Within this range, a wider viewing angle may be provided without lowering the luminance in the wide viewing angle mode, and in the narrow viewing angle mode, light is emitted at a viewing angle sufficiently smaller than the wide viewing angle mode to implement a more effective privacy protection function.

The privacy protection film PPF may accommodate the ink 140 including the pigment particles 141 and the solvent 142 charged in the plurality of accommodation portions CP and implement the switch between the wide viewing angle mode and the narrow viewing angle mode by the applied voltage.

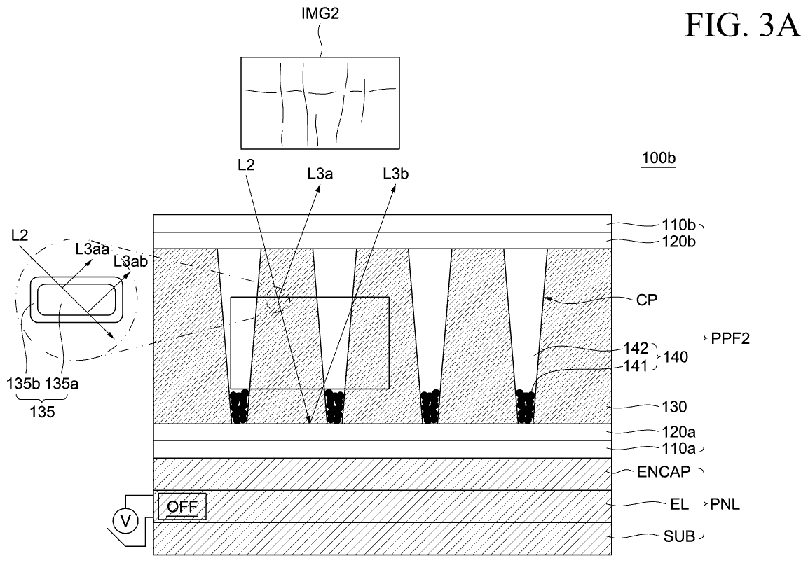

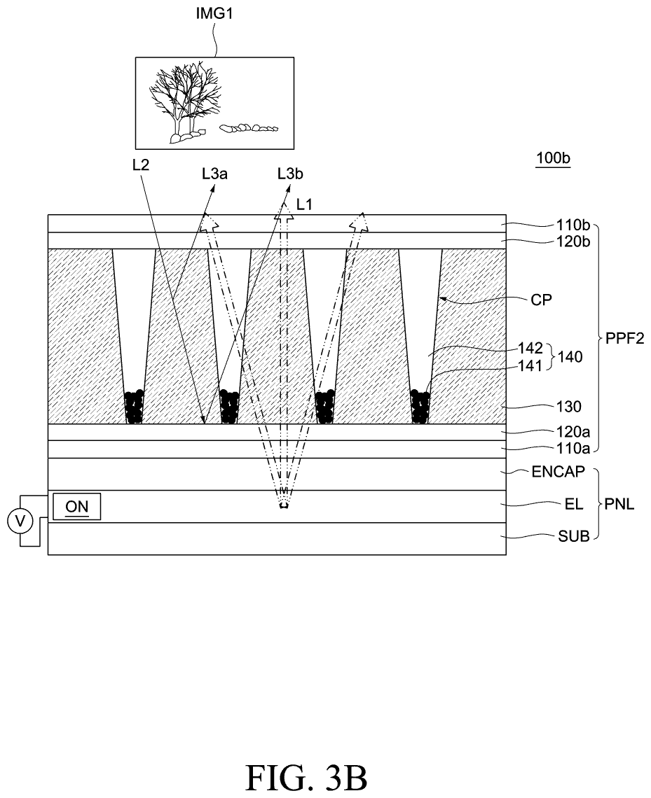

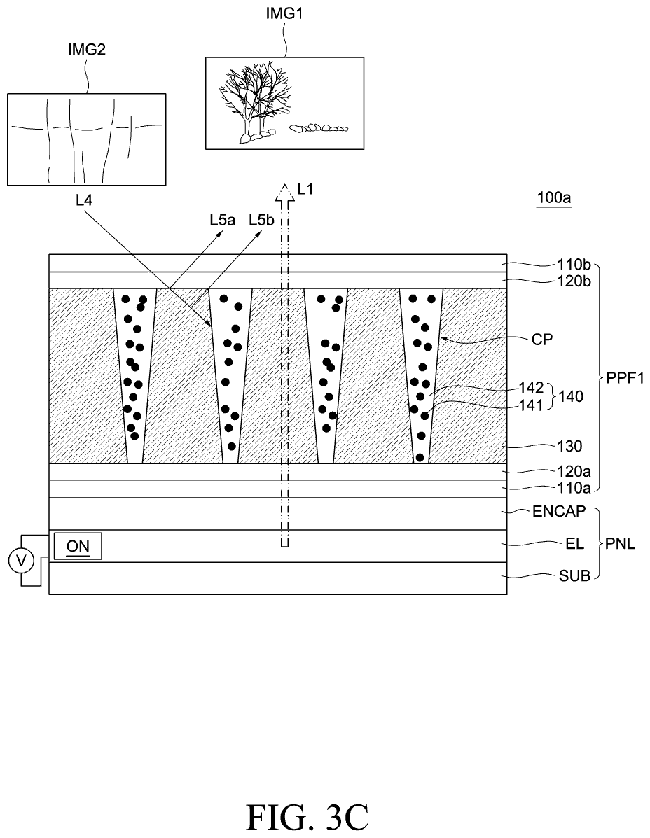

Hereinafter, a content in which an image due to external light reflection is implemented according to a driving mode of the display panel and a driving mode of the privacy protection film will be described in detail with reference to FIGS. 3A to 3C together.

FIG. 3A is a schematic cross-sectional view for illustrating image implementation by external light reflection when the privacy protection film is in a wide viewing angle mode and the display panel is in a non-driving mode in the display device according to an example embodiment of the present disclosure.

As shown in FIG. 3A, the display panel PNL is a non-driving mode that does not display an image, and the switch of the display panel PNL is turned off so that light is not emitted from the organic light emitting element EL. Accordingly, light is not incident on the privacy protection film PPF2. The privacy protection film PPF2 is in a wide viewing angle mode in which the charged pigment particles 141 in the accommodation portion CP move to be adjacent to the first electrode 120a to provide a wide viewing angle.

External light L2 incident on the privacy protection film is reflected in the decor resin layer 130 from the upper portion of the privacy protection film PPF2 to be emitted as the first reflected light L3a and the second reflected light L3b. In this case, the first reflected light L3a and the second reflected light L3b constructively interfere with each other to generate a specific color or pattern.

More specifically, the external light L2 is reflected by a plurality of interfaces of the optical interference particles 135 in the decor resin layer 130 to be emitted as the first reflected light L3aa and the second reflected light L3ab. A part of the external light L2 incident on the optical interference particle 135 is reflected as the first reflected light L3aa at the first interface between the core 135a constituting the optical interference particle 135 and the upper shell 135b, and the other part of the external light L2 is reflected as the second reflected light L3ab at the second interface between the core 135a and the shell 135b.

In this case, another part of the external light L2 is refracted at a specific refractive angle at the first interface between the core 135a and the upper shell 135b due to a difference in refractive index between the core 135a and the shell 135b, and then is reflected at the second interface between the core 135a and the shell 135b and emitted as the second reflected light L3ab through the first interface. Here, the first reflected light L3aa and the second reflected light L3ab have a light path difference according to the refraction by the difference in refractive index between the core 135a and the shell 135b and the thickness of the core 135a, and constructive interference with each other according to the light path difference and the wavelength to generate a reflective image having a specific color or pattern.

In particular, since the display panel PNL disposed under the privacy protection film PPF has a black color because the display panel PNL has a non-driving mode, the reflected image due to the constructive interference of the first reflected light L3a and the second reflected light L3b may be well visible to the user. Accordingly, the user may visually recognize the second image IMG2, which is a reflected image generated by the decor resin layer 130 of the privacy protection film PPF, in the non-driving mode of the display panel PNL, without restricting the viewing angle.

Meanwhile, the color or pattern implemented by constructive interference of the reflected light may be changed according to the thicknesses of the core 135a and the shell 135b. For example, as the thickness of the shell 135b increases, the reflection color visually recognized may be adjusted by the change in the reflection wavelength. Specifically, in the case of the optical interference particles 135 including a 3 μm-thick core 135a made of mica and a shell 135b made of titania (TiO2), as the thickness of the titania (TiO2) increases from 50 nm to 300 nm, the reflective color may change from yellow to green through red and blue.

In the meantime, even though in FIG. 3A, it is illustrated that the privacy protection film is in the wide viewing angle mode, when the privacy protection film is in the narrow viewing angle mode, the external light may be constructively interfered with by the optical interference particles 135 of the decor resin layer 130. Even in this case, since the display panel PNL has a black color because the display panel PNL is in a non-driving mode, a reflective image having a color or pattern due to constructive interference of reflected light may be visually recognized by the user.

FIG. 3B is a schematic cross-sectional view for illustrating image implementation by external light reflection when the privacy protection film is in a wide viewing angle mode and the display panel is in a driving mode in the display device according to an example embodiment of the present disclosure.

As shown in FIG. 3B, the display panel PNL is a driving mode for displaying an image, and a switch of the display panel PNL is turned on to emit light from the organic light emitting element EL and incident to a lower portion of the privacy protection film PPF2.

At this time, as illustrated in FIG. 3A, the external light L2 is reflected in the decor resin layer 130 in the privacy protection film PPF2 illustrated in FIG. 3B and emitted as the first reflected light L3a and the second reflected light L3b. In this case, the first reflected light L3a and the second reflected light L3b may constructively interfere with each other to generate a specific color or pattern.

However, unlike FIG. 3A in which the display panel PNL is in the non-driving mode, in FIG. 3B in which the display panel PNL is in the driving mode, the display panel PNL is in the driving mode in which the display panel PNL displays an image, and light L1 emitted from the display panel PNL and incident on the privacy protection film passes through the decor resin layer 130 between the plurality of accommodation portions CP. In this case, since the privacy protection film PPF2 is in a wide viewing angle mode, the light L1 emitted from the display panel PNL may be incident while being inclined at a predetermined angle or more with respect to the front surface (z-axis). Since the amount of light of the light L1 emitted from the display panel PNL is significantly greater than the amount of light of the reflected light L3a and L3b, the reflected image formed by the constructive interference of the first reflected light L3a and the second reflected light L3b by the external light L2 is not visually recognized by the user, and the first image IMG1, which is an image displayed on the display panel PNL, may be visually recognized.

FIG. 3C is a schematic cross-sectional view for illustrating image implementation by external light reflection when the privacy protection film is in a narrow viewing angle mode and the display panel is in a driving mode in the display device according to an example embodiment of the present disclosure.

As shown in FIG. 3C, the display panel PNL is a driving mode for displaying an image, and a switch of the display panel PNL is turned on to emit light from the organic light emitting element EL and incident to a lower portion of the privacy protection film PPF1.

Unlike FIG. 3B, in which the display panel PNL is in the driving mode and the privacy protection film PPF2 is in the wide viewing angle mode, in FIG. 3C, the privacy protection film PPF1 is in the narrow viewing angle mode in which the pigment particles 141 charged are dispersed in the accommodation portion CP. Accordingly, as described with reference to FIG. 2A, in FIG. 3C, the viewing angle of the light L1 emitted from the display panel PNL and incident on the privacy protection film PPF1 is restricted by the charged pigment particles 141 dispersed in the accommodation part CP, so that the front luminance is high and the side luminance is low.

In this case, as illustrated in FIG. 3C, the external light L4 incident onto the privacy protection film PPF from the upper portion of the privacy protection film PPF may be emitted to the first reflected light L5a and the second reflected light L5b by the optical interference particles 135 included in the decor resin layer 130, and the reflected image having a color or a pattern may be implemented by constructive interference of the first reflected light L5a and the second reflected light L5b. At this time, the light L1 emitted from the display panel PNL is blocked by the charged pigment particles 141 dispersed in the accommodation part CP at an angle larger than the viewing angle so that the reflected image through the constructive interference of the reflected light caused by the external light L4 incident at an angle larger than the viewing angle may be visible to the user.

That is, when the privacy protection film PPF is in the narrow viewing angle mode, the reflected image implemented by the decor resin layer 130 may be visually recognized by the user at an angle exceeding the viewing angle. Accordingly, in the case of a conventional privacy protection film, unlike the case where only a black image is visually recognized at an angle exceeding a viewing angle, in the privacy protection film according to the example embodiment of the present disclosure, a reflective image having a specific color and pattern is visually recognized at an angle exceeding a viewing angle in a narrow viewing angle mode, so that various aesthetic functions may be added.

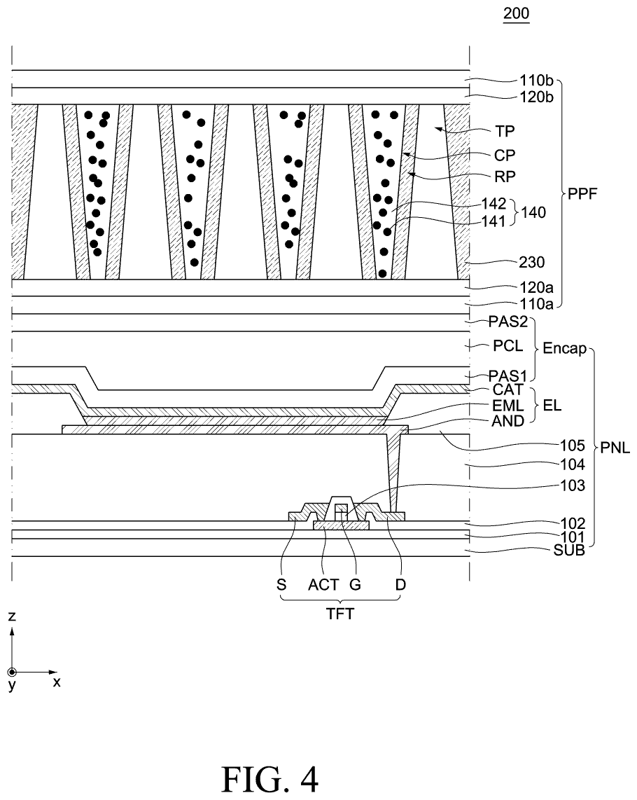

FIG. 4 is a schematic cross-sectional view of a display device including a privacy protection film according to another example embodiment of the present disclosure.

As shown in FIG. 4, a display device 200 according to an example embodiment of the present disclosure includes a display panel PNL and a privacy protection film PPF. In this case, the privacy protection film PPF includes a first substrate 110a, a first electrode 120a, a decor resin layer 230, a plurality of accommodation portions CP, and a plurality of transmission portions TP, an ink 140, a second electrode 120b, and a second substrate 110b, wherein the decor resin layer 230 includes a plurality of accommodation portions CP and a plurality of transmission portions TP. The display device illustrated in FIG. 4 is substantially the same as the display device 100 illustrated in FIG. 1 except that the decor resin layer 230 in the privacy protection film PPF further includes a plurality of transmissive portions TP, so that a redundant description will be omitted.

As shown in FIG. 4, the privacy protection film PPF includes a plurality of accommodation portions CP, a plurality of transmission portions TP, and a plurality of decoration portions RP.

The plurality of transmissive portions TP is an area that transmits light from the outside, and each of the plurality of transmissive portions TP is disposed between the plurality of accommodating portions CP. Accordingly, like the receiving portion CP, each of the plurality of transmissive portions TP is disposed to be spaced apart from each other at regular intervals in the first direction (x-axis direction) perpendicular to the thickness direction (z-axis direction) of the decor resin layer 230. Further, each of the plurality of transmissive portions TP extends along a second direction (y-axis direction) perpendicular to the first direction (x-axis direction). That is, each of the plurality of transmissive portions TP extends from any one corner of the first electrode 120a toward another corner parallel thereto to be formed in a stripe structure on the first electrode 120a.

Each of the plurality of transmissive portions TP may be formed such that a width decreases from the first electrode 120a toward the second electrode 120b. That is, the width of the lower surface of each of the plurality of transmissive portions TP is larger than the width of the upper surface. FIG. 4 illustrates that the cross-sectional shape of each of the plurality of transmission portions TP has a trapezoidal shape, but is not limited thereto. For example, the cross-sectional shape of each of the plurality of transmission portions TP may be an inverted trapezoidal shape like the accommodation portion CP.

Each of the plurality of transmissive portions TP may be formed to penetrate the decor resin layer 230, but is not limited thereto. For example, each of the plurality of transmissive portions TP may be formed to be spaced apart from any one of the first electrode 120a and the second electrode 120b. That is, only one of the upper and lower surfaces of the decor resin layer 230 may be opened so that the decor resin layer 230 does not penetrate.

The plurality of transmissive portions TP may transmit light incident from the outside. For example, light emitted from the display panel PNL disposed below the privacy protection film PPF may be transmitted from the bottom to the top.

Accordingly, the plurality of transmissive portions TP may be formed of an air layer or a transparent resin. The transparent resin may be formed of a transparent insulating resin capable of transmitting light incident from the bottom. For example, the transparent resin may include, but is not limited to, an acrylic resin.

Meanwhile, each of the plurality of transmissive portions TP is disposed to be spaced apart from the receiving portion CP. In this case, a space between the plurality of transmission portions TP and the plurality of accommodation portions CP may be defined as a plurality of decoration portions RP.

Each of the plurality of decoration parts RP is disposed between the accommodation part CP and the transmission part TP. The plurality of decoration parts RP transmits the internal light incident from the lower portion of the privacy protection film PPF and reflects at least a part of the external light incident from the upper portion of the privacy protection film PPF. The plurality of deco parts RP may implement a reflected image such as a color or a pattern through constructive interference of reflected light.

The plurality of deco parts RP is made of a material constituting the decor resin layer 230. That is, the plurality of decor portions RP includes the optical interference particles 135 and the base resin. A material constituting the plurality of deco parts RP is the same as that described with reference to FIG. 1, and thus a detailed description thereof will be omitted.

In this case, a ratio of an area of the plurality of accommodation portions CP and the plurality of decoration portions RP to an area of the plurality of transmission portions TP on the cross section may be 1:2 to 2:1 or approximately 1:1. The plurality of accommodation portions CP absorbs light emitted from the display panel PNL, and the plurality of decoration portions RP has a semi-transmissive characteristic that reflects external light while transmitting light emitted from the display panel PNL. When the area ratio of the sum of the areas of the plurality of accommodation portions CP and the plurality of decoration portions RP, and the transmission portion TP that transmits light satisfy the above range, the luminance of the display device is high and the reflected image due to the constructive interference of the reflected light may be visually recognized.

Meanwhile, the ratio of the area of the plurality of accommodation portions CP to the area of the plurality of decoration portions RP on the cross section may be 1:2 to 2:1, or approximately 1:1. When the ratio of the area of the plurality of accommodation portions CP to the area of the plurality of decor portions RP satisfies the above range, the viewing angle limitation performance is high, and the reflective image may be easily implemented due to the constructive interference of the reflected light.

The privacy protection film PPF according to another example embodiment of the present disclosure illustrated in FIG. 4 transmits light emitted from the display panel PNL to be visible to a user, and at the same time, a reflected image such as a color or a pattern may be implemented through constructive interference of reflected light caused by external light. In this case, the privacy protection film PPF may dispose the plurality of transmissive portions TP between the plurality of accommodating portions CP, thereby improving the luminance of the display device.

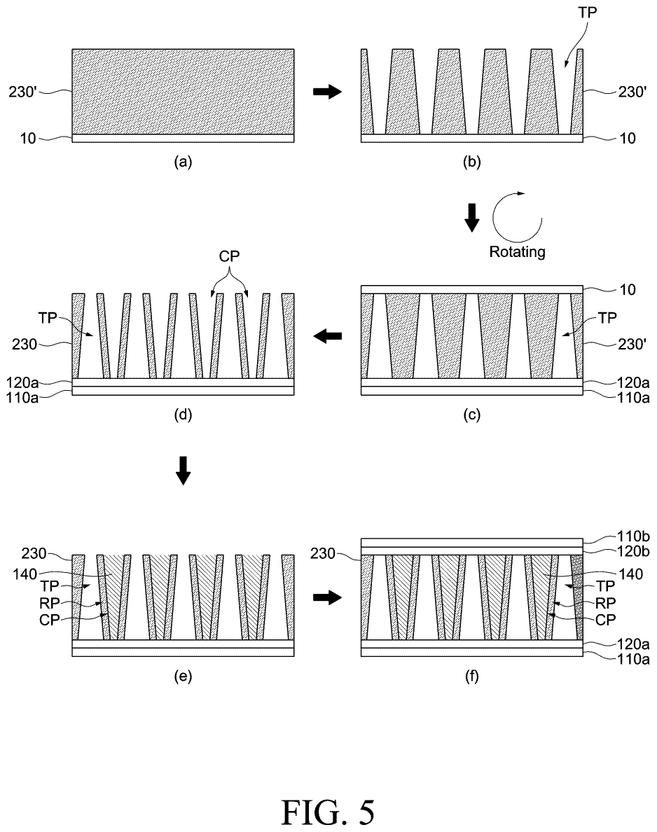

Hereinafter, a method of manufacturing a privacy protection film according to another embodiment of the present disclosure will be described in detail with reference to FIG. 5.

FIG. 5 is cross-sectional views for illustrating a method of manufacturing a privacy protection film according to an example embodiment of the present disclosure.

First, as shown in stage (a) of FIG. 5, a decor coating composition including a curable resin including optical interference particles 135 is prepared. The prepared decor coating composition is applied onto a release layer 10 and then cured to form a decor coating layer 230′.

Next, as shown in stage (b) of FIG. 5, the plurality of transmissive portions TP is formed on the decor coating layer 230′. At this time, the process of forming the transmissive portions TP may remove a part of the decor coating layer 230′ by performing a molding process or a photoresist process. In this case, the plurality of transmissive portions TP may be formed to have a width decrease from the upper surface toward the lower surface.

Next, as shown in stage (c) of FIG. 5, the decor coating layer 230′ is rotated so that the release layer 10 is located on the upper portion to invert the upper and lower surfaces thereof, and then the first substrate 110a and the first electrode 120a are formed on the lower surface of the decor coating layer 230′.

Next, as shown in stage (d) of FIG. 5, after removing the release layer 10, a plurality of accommodation portions CP are formed. The process of forming the accommodation part CP may be performed by a molding process to be located between a plurality of transmission parts TP and spaced apart from each of the transmission parts TP to remove a part of the decor coating layer 230′. At this time, the plurality of accommodation parts CP may be formed to have a width reduced from a top surface to a lower surface of the decor coating layer 230′.

Next, as shown in stage (e) of FIG. 5, the ink 140 including the pigment particles and the solvent charged is injected in each of the plurality of accommodation portions CP.

Next, as shown in stage (f) of FIG. 5, a privacy protection film may be manufactured by forming the second substrate 110b and the second electrode 120b on the top surface of the decor coating layer or decor resin layer 230.

The privacy protection film PPF of the present disclosure may be used in a display device.

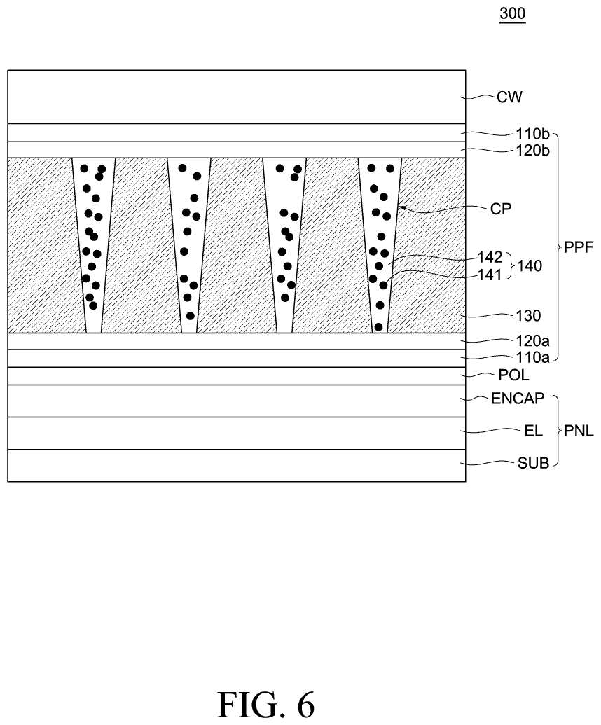

FIG. 6 is a schematic cross-sectional view of a display device according to yet another example embodiment of the present disclosure.

As shown in FIG. 6, a display device 300 according to an example embodiment of the present disclosure includes a display panel PNL, a polarization layer POL, a privacy protection film PPF, and a cover window CW. The display device 300 illustrated in FIG. 6 is substantially the same as the display device 100 illustrated in FIG. 1 except that the display device 300 further includes a polarization layer POL and a cover window CW, so that a redundant description will be omitted.

The polarization layer POL is disposed on the display panel PNL. In general, an organic light emitting display panel has a problem in that external light is reflected by a metal material to form a cathode using a metal material having a high reflectance, thereby reducing reflection visibility and a contrast ratio. Accordingly, in order to reduce reflection due to external light, a polarization layer POL for absorbing external light is disposed between the display panel PNL and the cover window CW. The polarization layer POL is a layer having a predetermined level of light transmittance and absorbs external light and reflected light thereof to prevent or suppress a decrease in contrast ratio.

The cover window CW protects the display device 300 from external impacts and scratches. Accordingly, the cover window CW may be formed of a material which is transparent and has high impact resistance and scratch resistance. Further, the cover window CW protects the display panel PNL from moisture permeating from the outside.

The cover window CW may be implemented as a plastic-based cover to reduce the thickness and weight of the display device 300. For example, the cover window CW may be a layer made of a polymer such as polyimide, polyamide imide, polyethylene terephthalate, polymethyl methacrylate, polypropylene glycol, and polycarbonate, but is not limited thereto. Further, the cover window CW may have a multi-layered structure in which various functional layers are stacked. For example, the cover window CW may include various functional layers such as an external light reflection reducing layer, a UV blocking layer, and a hard coating layer.

A privacy protection film PPF is disposed under the cover window CW. The privacy protection film PPF may be disposed on the display panel PNL to provide a narrow viewing angle mode in which an image caused by light emitted from the organic emission layer of the display panel PNL is provided so as to be visible to a user, and a wide viewing angle mode in which an image is provided so as to be visible to other people around the display panel PNL.

The configuration of the privacy protection film PPF, the narrow viewing angle mode and the wide viewing angle mode, and the implementation of the reflected image through the decor resin layer 130 are the same as those described above with reference to FIGS. 1, 2A, 2B, and 3A to 3C, and therefore, redundant descriptions thereof will be omitted.

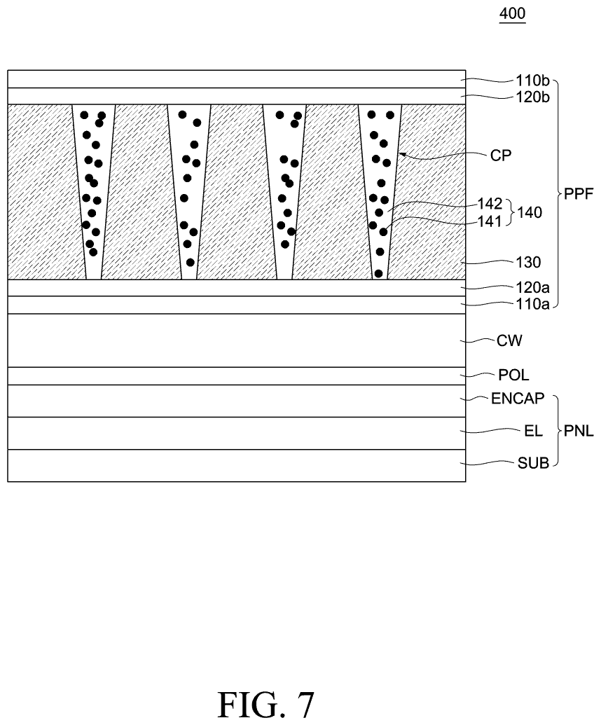

FIG. 7 is a schematic cross-sectional view of a display device according to yet another example embodiment of the present disclosure.

As shown in FIG. 7, a display device 400 according to another example embodiment of the present disclosure is substantially the same as the display device 300 illustrated in FIG. 6 except that a position of a privacy protection film PPF is different, so that a redundant description will be omitted.

The privacy protection film PPF is disposed between the polarization layer POL and the cover window CW. The privacy protection film PPF may be disposed on the display panel PNL to provide a narrow viewing angle mode in which an image caused by light emitted from the organic emission layer of the display panel PNL is provided so as to be visible to a user, and a wide viewing angle mode in which an image is provided so as to be visible to other people around the display panel PNL.

In addition, as the cover window CW is disposed on the privacy protection film PPF, the privacy protection film PPF may be protected from an external environment or a user's touch input.

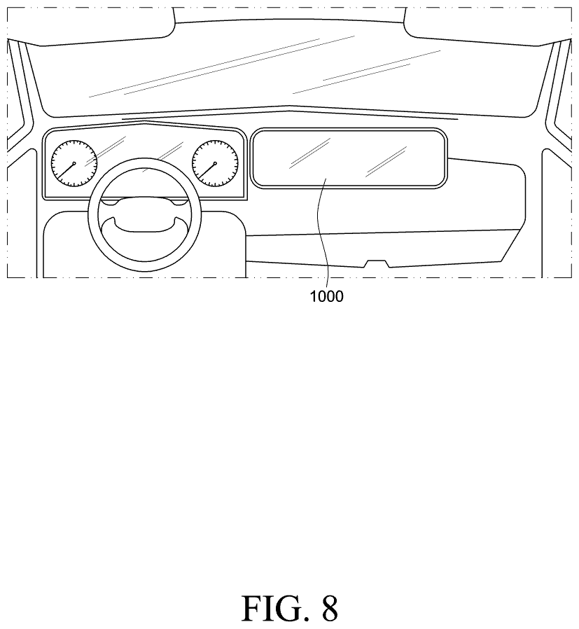

FIG. 8 is an example view in which a display device according to an example embodiment of the present disclosure is applied to a vehicle.

The display device 1000 according to the example embodiment of the present disclosure may be disposed on at least a part of a dashboard of a vehicle. The dashboard of the vehicle includes a configuration disposed in front of front seats (e.g., driver's seat and passenger seat) of the vehicle. For example, an input configuration for manipulating various functions (e.g., an air conditioner, an audio system, and a navigation system) inside the vehicle may be disposed on the dashboard of the vehicle.

In the display device 1000 according to the example embodiment of the present disclosure, the display device 1000 may be disposed on a dashboard of a vehicle and operate as an input unit for manipulating at least some of various functions of the vehicle. The display device 1000 may provide various information related to the vehicle, for example, driving information of the vehicle (for example, a current speed of the vehicle, a remaining fuel amount, and a driving distance), information on parts of the vehicle (for example, a degree of damage to a vehicle tire).

The display device 1000 may be disposed across the driver seat and the front passenger seat disposed in the front seats of the vehicle. The user of the display device 1000 may include a driver of the vehicle and a passenger riding in the passenger seat. Both the driver and the passenger of the vehicle may use the display device 1000.

The display device 1000 according to the example embodiment of the present disclosure includes a privacy protection film on the display panel PNL. The wide viewing angle mode and the narrow viewing angle mode may be freely selected according to the user's selection through the privacy protection film. At the same time, the privacy protection film may implement a reflective image such as a color or a pattern through constructive interference of reflected light during the reflection process of external light incident from the front surface of the display device 1000. A reflection image is implemented using a privacy protection film and the color or pattern of the reflection image is selectively adjusted to be integrated with the interior of the vehicle, thereby maximizing or improving aesthetics.

Hereinafter, the effects of the present disclosure described above will be described in more detail with reference to Examples and Comparative Examples. However, the following Examples are for illustration of the present disclosure, and the scope of the present disclosure is not limited by the following Examples.

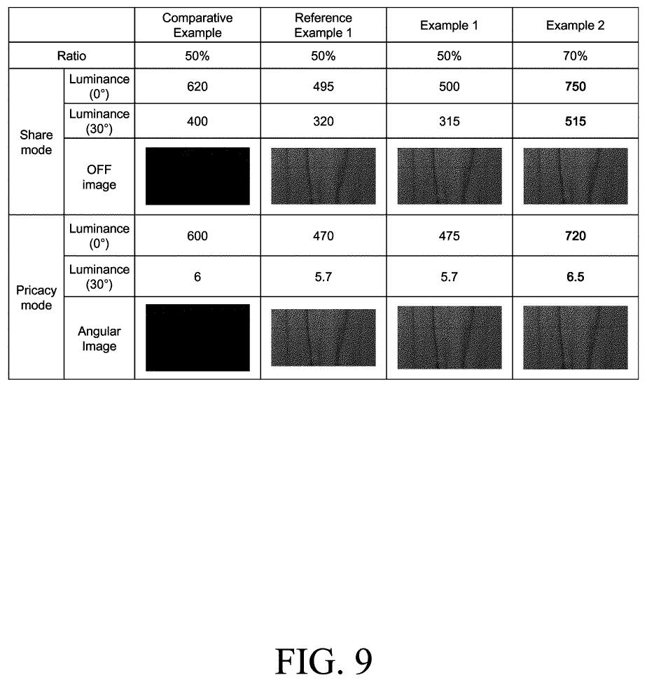

FIG. 9 is a table showing results of evaluating luminance with respect to a viewing angle and an image implemented according to a driving mode of each of Example 1, Example 2, Comparative Example, and Reference Example.

Example 1 is a privacy protection film shown in FIG. 1, and as an optical interference particle 135 constituting the decor resin layer 130, particles including a core 135a having a long axis and short axis ratio of 5:1 and a long axis length of 3 μm and made of mica and a shell 135b surrounding the core 135a and having a thickness of 200 nm and made of TiO₂ were used. The plurality of receiving portions CP formed in the decor resin layer 130 are formed to have a width of the bottom surface of the receiving portion CP of 8 μm, a width of the top surface of 24 μm, a height of 100 μm, and a gap of 100 μm, and ink 140 including carbon black and a solvent 142 charged is injected in the receiving portion CP.

Example 2 is the privacy protection film shown in FIG. 4, and compared with Example 1, a plurality of transmissive portions TP are formed between a plurality of receiving portions CP. Each transmission part TP has a lower surface width of 15 μm, an upper surface width of 6 μm, and a height of 100 μm, and is formed to be 6 μm spaced apart from the receiving part.

Comparative example is a privacy protection film having a structure including no optical interference particles compared to Example 1.

Reference example is a privacy protection film having a structure further including a reflective photosensitive layer including the optical interference particles 135 on the upper electrode compared to the comparative example.

In order to find out the driving characteristics of the privacy protection films manufactured according to Comparative Example and Reference Example 1 and Example 2, the luminance according to the viewing angle over time was measured. In addition, when the display panel PNL under the privacy protection film is in the non-driving mode, an image visible from the upper portion of the privacy protection film was photographed. Luminance was measured using SpectraDo PR-680, and the result thereof is shown in FIG. 9.

As shown in FIG. 9, in the comparative example, the display panel PNL was not visually recognized and black was visually recognized in the non-driving mode. However, in Examples 1 and 2, including the decor resin layer 130, constructive interference of reflected light occurred due to the optical interference particles 135, and an image with a dark yellow color was partially visually recognized. That is, even when the display device is not driven, a specific color or pattern may be visually recognized in the display device, and by using this, it is possible to match the surrounding interior to improve the aesthetics.

On the other hand, in Example 2, by further forming a deco part in the decor resin layer 130, it was confirmed that the luminance was improved at both the front surface (0°) and a specific viewing angle (30°) compared to Example 1.

Example embodiments of the present disclosure can also be described as follows:

A display device according to an example embodiment of the present disclosure includes a display panel and a privacy protection film disposed on the display panel and selectively restricting a viewing angle. The privacy protection film includes a first substrate, a first electrode disposed on the first substrate, a decor resin layer disposed on the first electrode and including a plurality of accommodation portions, and implementing an external light reflection image, a second electrode disposed on the decor resin layer, a second substrate disposed on the second electrode, and an ink received in each of the plurality of accommodation portions and including a plurality of charged pigment particles and a solvent having an electrical polarity, and the decor resin layer includes optical interference particles.

The optical interference particles may include materials configured to cause constructive interference of reflected light due to external light at a plurality of interfaces.

An optical interference particle, among the optical interference particles, may be a plate-shaped particle including a core and a shell having a refractive index greater than a refractive index of the core.

The refractive index of the core may be 1.6 or less, and the refractive index of the shell may be 2.0 or greater.

The core may include at least one of mica, silica (SiO₂), and a low refractive polymer.

The shell may include one or more of alumina (Al₂O₃), titania (TiO₂), iron oxide (Fe₂O₃), zirconia (ZrO₂), ceria (CeO₂) and vanadia (V₂O₅).

A size of the core may be 3 μm or less

A thickness of the shell may be 50 to 300 nm.

The charged pigment particles may be positively or negatively charged carbon nanotubes or carbon black or electrophoretic particles.

Each of the plurality of accommodation portions may be disposed to face the second electrode, and the plurality of accommodation portions may be spaced apart from each other at a predetermined interval along a first direction perpendicular to a thickness direction of the decor resin layer, and extend along a thickness direction and a second direction perpendicular to the first direction.

The width of each of the plurality of accommodation portions may increase as it approaches the second electrode from the first electrode.

The decor resin layer may further include a plurality of transmissive portions positioned between the plurality of receiving portions.

The width of each of the plurality of transmissive portions may decrease as it approaches the second electrode from the first electrode.

The decor resin layer may include a plurality of decor portions positioned between an accommodation portion, among a plurality of accommodation portions, and a transmission portion, among a plurality of transmission portions, and including light interference particles, and a ratio of a sum of areas of the plurality of accommodation portions and the plurality of decor portions to a sum of areas of the plurality of transmission portions on a cross section along a thickness direction may be 1:2 to 2:1.

A ratio of the area of the plurality of accommodation portions to an area of the plurality of decor portions on the cross section along the thickness direction may be 1:2 to 2:1.

Each of the plurality of transmission units may comprise a transparent resin or an air layer.

The display device may further include a polarizing layer disposed on the display panel, and a cover window disposed on the polarizing layer. The privacy protection film may be disposed between the polarizing layer and the cover window or under the cover window.

Although various example embodiments of the present disclosure have been described in detail with reference to the accompanying drawings, the present disclosure is not limited thereto and may be embodied in various forms without departing from the technical concept of the present disclosure. Therefore, the example embodiments of the present disclosure are provided for illustrative purposes only but not intended to limit the technical concept of the present disclosure. The scope of the technical concept of the present disclosure is not limited thereto. Therefore, it should be understood that the above-described embodiments are illustrative in all embodiments and do not limit the present disclosure. The protective scope of the present disclosure should be construed based on the following claims, and all the technical concepts in the equivalent scope thereof should be construed as falling within the scope of the present disclosure.

What is claimed is:

1. A display device, comprising:
a display panel; and
a privacy protection film disposed on the display panel and selectively restricting a viewing angle,
wherein the privacy protection film includes:
a first substrate;
a first electrode disposed on the first substrate;
a decor resin layer disposed on the first electrode, including a plurality of accommodation portions, and implementing an external light reflection image;
a second electrode disposed on the decor resin layer;
a second substrate disposed on the second electrode; and
an ink received in each of the plurality of accommodation portions and including
a plurality of charged pigment particles and a solvent having an electrical polarity, and
wherein the decor resin layer includes optical interference particles.

2. The display device according to claim 1, wherein the optical interference particles include materials configured to cause constructive interference of reflected light due to external light at a plurality of interfaces.

3. The display device according to claim 1, wherein a optical interference particle, among the optical interference particles, is a plate-shaped particle including a core and a shell having a refractive index greater than that of the core.

4. The display device according to claim 3, wherein:
the refractive index of the core is 1.6 or less and
the refractive index of the shell is 2.0 or greater.

5. The display device according to claim 3, wherein the core includes at least one of mica, silica (SiO₂), and a low refractive polymer.

6. The display device according to claim 3, wherein the shell comprises at least one of alumina (Al₂O₃), titania (TiO₂), iron oxide (Fe₂O₃), zirconia (ZrO₂), ceria (CeO₂) and vanadia (V₂O₅).

7. The display device according to claim 3, wherein:
a size of the core is 3 μm or less, and
a thickness of the shell is 50 to 300 nm.

8. The display device according to claim 1, wherein the charged pigment particles are positively or negatively charged carbon nanotubes, carbon black, or electrophoretic particles.

9. The display device according to claim 1, wherein:
each of the plurality of accommodation portions is disposed to face the second electrode, and
the plurality of accommodation portions are spaced apart from each other at a predetermined interval along a first direction perpendicular to a thickness direction of the decor resin layer and extend along the thickness direction and a second direction perpendicular to the first direction.

10. The display device according to claim 9, wherein each of the plurality of accommodation portions increases in width as it approaches the second electrode from the first electrode.

11. The display device according to claim 1, wherein the decor resin layer further includes a plurality of transmissive portions positioned between the plurality of receiving portions.

12. The display device according to claim 11, wherein each of the plurality of transmissive portions decreases in width from the first electrode to the second electrode.

13. The display device according to claim 11, wherein:
the decor resin layer includes a plurality of decor portions positioned between an accommodation portion, among the plurality of accommodation portions, and a transmission portion, among the plurality of transmission portions, and including the optical interference particles, and
a ratio of a sum of areas of the plurality of accommodation portions and the plurality of decor portions to a sum of areas of the plurality of transmission portions on a cross-section along a thickness direction is 1:2 to 2:1.

14. The display device according to claim 13, wherein a ratio of an area of the plurality of accommodation portions to an area of the plurality of decor portions on a cross-section along the thickness direction is 1:2 to 2:1.

15. The display device according to claim 11, wherein each of the plurality of transmissive portions comprises a transparent resin or an air layer.

16. The display device according to claim 1, further comprising:
a polarizing layer disposed on the display panel and a cover window disposed on the polarizing layer,
wherein the privacy protection film is disposed between the polarizing layer and the cover window or under the cover window.
